(19) United States
(12) Patent Application Publication
(10) Pub. No.: US 2020/0241662 A1
(43) Pub. Date: Jul. 30, 2020

(54) TOUCH SYSTEM

(71) Applicant: HIMAX TECHNOLOGIES LIMITED, Tainan City (TW)

(72) Inventors: Cheng-Hung Tsai, Tainan City (TW); Chin-Yuan Chiang, Tainan City (TW); Wai-Pan Wu, Tainan City (TW); Li-Lin Liu, Tainan City (TW); Shen-Feng Tai, Tainan City (TW)

(21) Appl. No.: 16/256,498

(22) Filed: Jan. 24, 2019

(51) Int. Cl. G06F 3/044; G06F 3/041

(52) U.S. Cl. CPC G06F 3/044; G06F 3/0416; G06F 3/0412

(57) ABSTRACT

A touch system includes channel electrodes that are mapped to touch pixels such that a number of the channel electrodes in each dimension is lower than a number of the touch pixels in said dimension. In one embodiment, each channel electrode has different adjacent channel electrodes at different positions of the mapped touch pixel. In another embodiment, each touch pixel in said dimension is laterally extended to at least one adjacent touch pixel in said dimension. In a further embodiment, original sensing channel electrodes and mirrored sensing channel electrodes are alternately corresponded to the driving channel electrodes.

### BACKGROUND OF THE INVENTION 1. Field of the Invention

The present invention generally relates to a touch system, and more particularly to a capacitive touch system with reduced amount of channel electrodes.

### 2. Description of Related Art

A touch screen is an input/output device that is commonly composed of a touch panel (with associated circuits) and a display panel (such as liquid crystal display (LCD) panel). The touch screen enables a user to interact directly with what is displayed on the display panel, and has been widely adapted to electronic devices such as smart phones, tablet PCs, wearables, etc.

Capacitive sensing is popularly adopted among a variety of touching sensing technologies. The electrostatic field of the touch screen may be distorted and measured as a change in capacitance, when the human body touches the surface of the touch screen.

As the resolution of the touch screen increases, more channels and associated routing space are required. Moreover, larger circuits coping with more channels are demanded. Therefore, the active area of the touch screen will be sacrificed, and performance and sensitivity will be affected.

A need has thus arisen to propose a novel capacitive touch screen with increased resolution but without sacrificing performance and sensitivity.

### SUMMARY OF THE INVENTION

In view of the foregoing, it is an object of the embodiment of the present invention to provide a capacitive touch system with reduced amount of channel electrodes, enhanced accuracy, and/or improvement on ghost touch issue.

According to one embodiment, a self-capacitance touch system includes a touch panel and a sensing circuit. The touch panel has a plurality of touch pixels and a plurality of channel electrodes. The sensing circuit receives and processes sensed signals from the touch panel through the channel electrodes. The channel electrodes are mapped to the touch pixels in a manner such that a number of the channel electrodes in each dimension is lower than a number of the touch pixels in said dimension. Each channel electrode has different adjacent channel electrodes at different positions of the mapped touch pixel. In another embodiment, each touch pixel in said dimension is laterally extended to at least one adjacent touch pixel in said dimension.

According to a further embodiment, a mutual-capacitance touch system includes a touch panel, a driving circuit and a sensing circuit. The touch panel has a plurality of touch pixels, a plurality of driving channel electrodes and a plurality of sensing channel electrodes. The driving circuit generates driving signals transferred to the touch panel through the driving channel electrodes. The sensing circuit receives and processes sensed signals from the touch panel through the sensing channel electrodes. The driving or sensing channel electrodes are mapped to the touch pixels in a manner such that a number of the channel electrodes in each dimension is lower than a number of the touch pixels in said dimension. Original sensing channel electrodes in said dimension are mirrored in sequence to result in mirrored sensing channel electrodes, and the original sensing channel electrodes and the mirrored sensing channel electrodes are then alternately corresponded to the driving channel electrodes. Alternatively, original driving channel electrodes in said dimension are mirrored in sequence to result in mirrored driving channel electrodes, and the original driving channel electrodes and the mirrored driving channel electrodes are then alternately corresponded to the sensing channel electrodes.

### BRIEF DESCRIPTION OF THE DRAWINGS

FIG. 1 shows a block diagram illustrating a self-capacitance touch system adaptable to a touch screen according to one embodiment of the present invention;

FIG. 2 exemplifies 24 channel electrodes RX1-RX24, which are mapped to 48 touch pixels in the same dimension;

FIG. 3A shows a top view illustrating a pattern of touch pixels in an exemplary dimension according to one embodiment of the present invention;

FIG. 3B shows a top view illustrating another pattern of touch pixels in an exemplary dimension according to another embodiment of the present invention;

FIG. 4 shows a block diagram illustrating a mutual-capacitance touch system adaptable to a touch screen according to another embodiment of the present invention; and

FIG. 5 exemplifies alternately corresponding the original sensing channel electrodes RX1-RX12 and the mirrored sensing channel electrodes RX12-RX1 to the driving electrodes TX1-TX4.

### DETAILED DESCRIPTION OF THE INVENTION

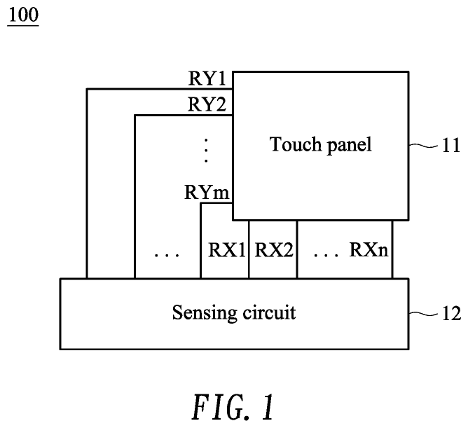

FIG. 1 shows a block diagram illustrating a self-capacitance touch system 100 adaptable to a touch screen according to one embodiment of the present invention. In the embodiment, the self-capacitance touch system (touch system hereinafter) 100 may include a touch panel 11 that may be embedded either in or out of a display panel (e.g., liquid crystal display (LCD) panel). Generally speaking, the touch panel 11 with touch pixel resolution pxq may be composed of p rows and q column of touch pixels.

The touch system 100 of the embodiment may include a plurality of channel electrodes RX1-RXn (along y-coordinate) and RY1-RYm (along x-coordinate), through which sensed signals from the touch panel 11 may be collected. The touch system 100 of the embodiment may include a sensing circuit 12 configured to receive and process the sensed signals to determine a touch position on the touch panel 11.

According to one aspect of the embodiment, a number of the channel electrodes in each dimension (or coordinate) is lower than a number of touch pixels in that dimension. Alternatively speaking, in the embodiment, each channel electrode may be mapped (or connected) to more than one touch pixel in the same dimension.

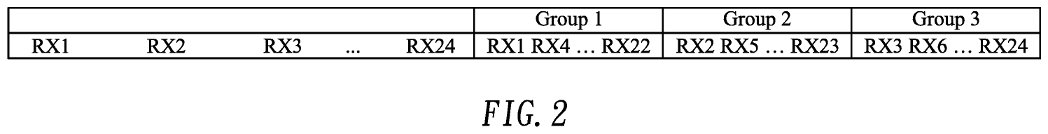

FIG. 2 exemplifies 24 channel electrodes RX1-RX24, which are mapped to 48 touch pixels in the same dimension. Specifically, the channel electrodes RX1-RX24 are mapped in a first order (e.g., numerical order) to the first 24 touch pixels, and the channel electrodes RX1-RX24 are then mapped in a second order (being different from the first order) to the next 24 touch pixels. In the embodiment as exemplified in FIG. 2, regarding the second order, the channel electrodes RX1-RX24 are assigned to plural (e.g., three) groups in turn. Therefore, the first channel electrode RX1 is assigned to the first group, the second channel electrode RX2 is assigned to the second group, the third channel electrode RX3 is assigned to the third group, the fourth channel electrode RX4 is assigned to the first group, the fifth channel electrode RX5 is assigned to the second group, the sixth channel electrode RX6 is assigned to the third group, and so on. Alternatively speaking, the channel electrodes are assigned to the same group (of totally r groups) every r channel electrodes.

According to another aspect of the embodiment, each channel electrode may have different adjacent channel electrodes (combination) at different mapped touch pixel positions. As exemplified in FIG. 2, the channel electrode RX2 at the left-hand mapped touch pixel position has adjacent channel electrodes RX1 and RX3, while the channel electrode RX2 at the right-hand mapped touch pixel position has adjacent channel electrodes RX22 and RX5. Accordingly, the touch position on the touch panel 11 may be properly determined without ghost issue for the reason that the sensed signals on the different channel electrodes combinations are distinct.

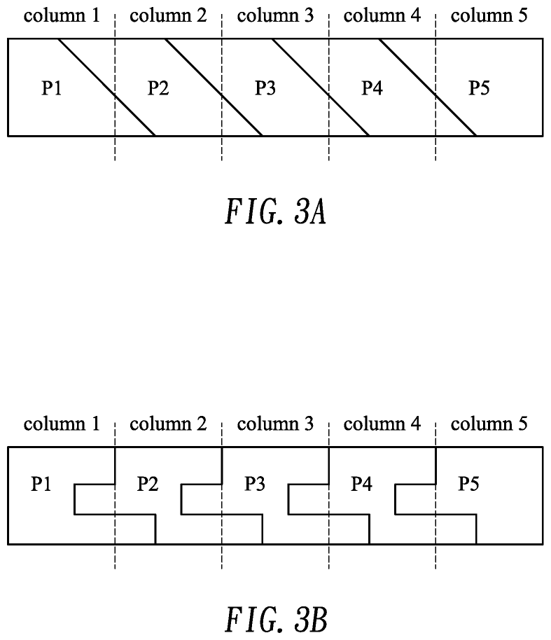

FIG. 3A shows a top view illustrating a pattern of touch pixels P1-P5 in an exemplary dimension (or coordinate) according to one embodiment of the present invention. According to a further aspect of the embodiment, each touch pixel in each dimension may be laterally extended to an adjacent touch pixel (or pixels) in that dimension. As exemplified in FIG. 3A, the touch pixels P1-P5 are slanted, and the second touch pixel P2, for example, is laterally extended to the (left-hand) first touch pixel P1 and the (right-hand) third touch pixel P3. Accordingly, the touch position on the touch panel 11 may be properly determined with more precision as each touch pixel possesses information at not only its touch pixel position but also adjacent touch pixel position(s). It is appreciated that the pattern of the touch pixels of the embodiment is not limited to that shown in FIG. 3A, but may be modified according to specific applications. FIG. 3B shows a top view illustrating another pattern of touch pixels P1-P5 in an exemplary dimension (or coordinate) according to another embodiment of the present invention. As exemplified in FIG. 3B, the touch pixels P1-P5 are jigsaw-shaped, and the second touch pixel P2, for example, is laterally extended to the (left-hand) first touch pixel P1 and the (right-hand) third touch pixel P3.

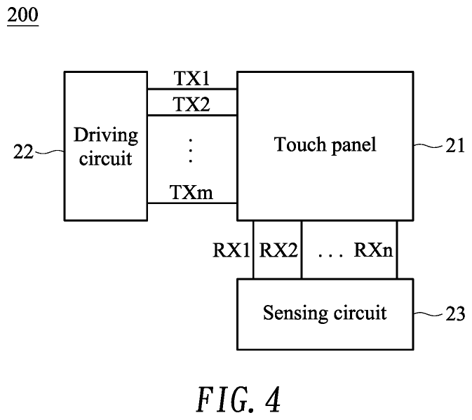

FIG. 4 shows a block diagram illustrating a mutual-capacitance touch system 200 adaptable to a touch screen according to another embodiment of the present invention. In the embodiment, the mutual-capacitance touch system (touch system hereinafter) 200 may include a touch panel 21 that may be embedded either in or out of a display panel (e.g., liquid crystal display (LCD) panel). Generally speaking, the touch panel 21 with touch pixel resolution pxq may be composed of p rows and q column of touch pixels.

The touch system 200 of the embodiment may include a driving circuit 22 configured to generate driving signals, which are transferred to the touch panel 21 through driving channel electrodes TX1-TXm (along x-coordinate). The touch system 200 of the embodiment may include a plurality of sensing channel electrodes RX1-RXn (along y-coordinate), through which sensed signals from the touch panel 21 may be collected. The touch system 200 of the embodiment may include a sensing circuit 23 configured to receive and process the sensed signals to determine a touch position on the touch panel 21.

Similar to the self-capacitance touch system 100 (FIG. 1), in the touch system 200 (FIG. 4) of the embodiment, a number of the channel electrodes in each dimension (or coordinate) is lower than a number of touch pixels in that dimension. Alternatively speaking, in the embodiment, each (driving/sensing) channel electrode may be mapped to more than one touch pixel in the same dimension.

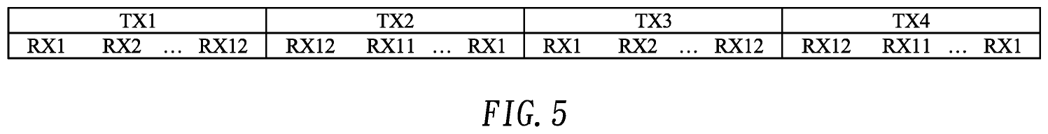

According to another aspect of the embodiment, original sensing channel electrodes RX1-RXn in each dimension are mirrored in sequence to result in mirrored sensing channel electrodes RXn-RX1. The original sensing channel electrodes RX1-RXn and the mirrored sensing channel electrodes RXn-RX1 are then alternately corresponded to the driving channel electrodes TX1-TXm. FIG. 5 exemplifies alternately corresponding the original sensing channel electrodes RX1-RX12 and the mirrored sensing channel electrodes RX12-RX1 to the driving channel electrodes TX1-TX4. In an alternative embodiment, original driving channel electrodes TX1-TXm in each dimension are mirrored in sequence to result in mirrored driving channel electrodes TXm-TX1. The original driving channel electrodes TX1-TXm and the mirrored driving channel electrodes TXm-TX1 are then alternately corresponded to the sensing electrodes RX1-RXn.

Although specific embodiments have been illustrated and described, it will be appreciated by those skilled in the art that various modifications may be made without departing from the scope of the present invention, which is intended to be limited solely by the appended claims.

What is claimed is:

1. A touch system, comprising:
a touch panel having a plurality of touch pixels, the touch panel including a plurality of channel electrodes; and
a sensing circuit that receives and processes sensed signals from the touch panel through the channel electrodes;
wherein the channel electrodes are mapped to the touch pixels in a manner such that a number of the channel electrodes in each dimension is lower than a number of the touch pixels in said dimension; and
wherein each channel electrode has different adjacent channel electrodes at different positions of the mapped touch pixel.

2. The system of claim 1, wherein the touch system comprises a self-capacitance touch system.

3. The system of claim 1, wherein each channel electrode is mapped to more than one touch pixel in said dimension.

4. The system of claim 1, further comprising a display panel, in or out of which the touch panel is embedded, thereby resulting in a touch screen.

5. A touch system, comprising:
a touch panel having a plurality of touch pixels, the touch panel including a plurality of channel electrodes; and
a sensing circuit that receives and processes sensed signals from the touch panel through the channel electrodes;
wherein the channel electrodes are mapped to the touch pixels in a manner such that a number of the channel electrodes in each dimension is lower than a number of the touch pixels in said dimension; and
wherein each said touch pixel in said dimension is laterally extended to at least one adjacent touch pixel in said dimension.

6. The system of claim 5, wherein each said touch pixel except an end touch pixel in said dimension is laterally extended to adjacent touch pixels at both ends in said dimension.

7. The system of claim 5, wherein the touch pixels are slanted such that each said touch pixel except an end touch pixel in said dimension is laterally extended to a left-hand adjacent touch pixel and to a right-hand adjacent touch pixel.

8. The system of claim 5, wherein the touch pixels are jigsaw-shaped such that each said touch pixel except an end touch pixel in said dimension is laterally extended to a left-hand adjacent touch pixel and to a right-hand adjacent touch pixel.

9. The system of claim 5, wherein the touch system comprises a self-capacitance touch system.

10. The system of claim 5, wherein each channel electrode is mapped to more than one touch pixel in said dimension.

11. The system of claim 5, further comprising a display panel, in or out of which the touch panel is embedded, thereby resulting in a touch screen.

12. A touch system, comprising:
a touch panel having a plurality of touch pixels, the touch panel including a plurality of driving channel electrodes and a plurality of sensing channel electrodes;
a driving circuit that generates driving signals transferred to the touch panel through the driving channel electrodes; and
a sensing circuit that receives and processes sensed signals from the touch panel through the sensing channel electrodes;
wherein the driving or sensing channel electrodes are mapped to the touch pixels in a manner such that a number of the channel electrodes in each dimension is lower than a number of the touch pixels in said dimension; and
wherein original sensing channel electrodes in said dimension are mirrored in sequence to result in mirrored sensing channel electrodes, and the original sensing channel electrodes and the mirrored sensing channel electrodes are then alternately corresponded to the driving channel electrodes; or original driving channel electrodes in said dimension are mirrored in sequence to result in mirrored driving channel electrodes, and the original driving channel electrodes and the mirrored driving channel electrodes are then alternately corresponded to the sensing channel electrodes.

13. The system of claim 12, wherein the touch system comprises a mutual-capacitance touch system.

14. The system of claim 12, wherein each driving or sensing channel electrode is mapped to more than one touch pixel in said dimension.

15. The system of claim 12, further comprising a display panel, in or out of which the touch panel is embedded, thereby resulting in a touch screen.
